(19) United States
(12) Patent Application Publication
(10) Pub. No.: US 2017/0348724 A1
(43) Pub. Date: Dec. 7, 2017

(54) CAULKING GUN

(71) Applicant: SIANG SYUAN FU ENTERPRISE CO., LTD., Changhua County (TW)

(72) Inventor: HUNG-CHIH HUNG, Changhua County (TW)

(21) Appl. No.: 15/464,906

(22) Filed: Mar. 21, 2017

(30) Foreign Application Priority Data
Jun. 7, 2016 (TW) 105117964

(51) Int. Cl. B05C 17/01; B05C 17/005

(52) U.S. Cl. CPC B05C 17/0126; B05C 17/00596

(57) ABSTRACT

A caulking gun is provided, including: a gun body, including a side wall and for a sealant cartridge to be assembled thereto; a limitation member, swingably assembled to the gun body; a pushing rod, movably disposed in the gun body and disposed through the limitation member and the side wall, the pushing rod optionally frictionally gripped by the limitation member for pushing the sealant cartridge; an abutting mechanism, movably disposed through the side wall and radially disengageable directly from the pushing rod, two ends of the abutting mechanism respectively abutting against the driving member and the limitation member, the abutting mechanism including an abutting portion and an elastic member, the elastic member being arranged between the abutting portion and the driving member.

### BACKGROUND OF THE INVENTION

### Field of the Invention

The present invention relates to a caulking gun.

### Description of the Prior Art

Usually, a caulking gun is for caulking gaps at the corner or connection of two objects, and it is quick and convenient to use the caulking gun.

However, there is non-actuating action in the conventional caulking gun. When a user presses a pressing shank, a driving member cannot be driven immediately to actuate the pushing rod to move forward to abut against a sealant cartridge, so it is inefficient. In addition, an elastic member which is for abutting a limitation member is arranged on an outer side of a gun body or sleeved on a pushing rod, when the elastic member is arranged on the outer side of the gun body, the elastic member may be easily damaged or fallen off; when the elastic member is sleeved on the pushing rod, the elastic member abrades with the pushing rod easily and produces noises; therefore, an additional space is required for the elastic member to be arranged therein.

The present invention has arisen to mitigate and/or obviate the afore-described disadvantages.

### SUMMARY OF THE INVENTION

The major object of the present invention is to provide a caulking gun, which has a simple and stable structure without non-actuating action.

To achieve the above and other objects, a caulking gun is provided, including: a gun body, including a side wall and for a sealant cartridge to be assembled thereto; a limitation member, swingably assembled to the gun body; a pushing rod, movably assembled to the gun body and disposed through the limitation member and the side wall, the pushing rod optionally frictionally gripped by the limitation member for pushing the sealant cartridge; a driving member, movably disposed within the gun body, the driving member and the limitation member being located by two opposite sides of the side wall, the driving member capable of driving the pushing rod; an abutting mechanism, movably disposed through the side wall and radially disengageable directly from the pushing rod, two ends of the abutting mechanism respectively abutting against the driving member and the limitation member, the abutting mechanism including an abutting portion and an elastic member, the elastic member being arranged between the abutting portion and the driving member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown view of the preferred embodiment of the present invention;

FIG. 3 is a drawing of the preferred embodiment of the present invention in application;

FIGS. 4 to 6 are drawings showing the preferred embodiment of the present invention in operation;

FIG. 7 is a stereogram of another preferred embodiment of the present invention; and

FIG. 8 is a partially-enlarged view of FIG. 7.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

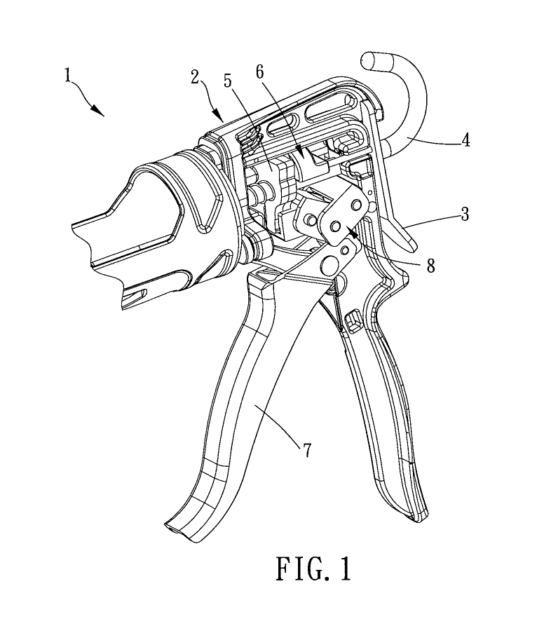

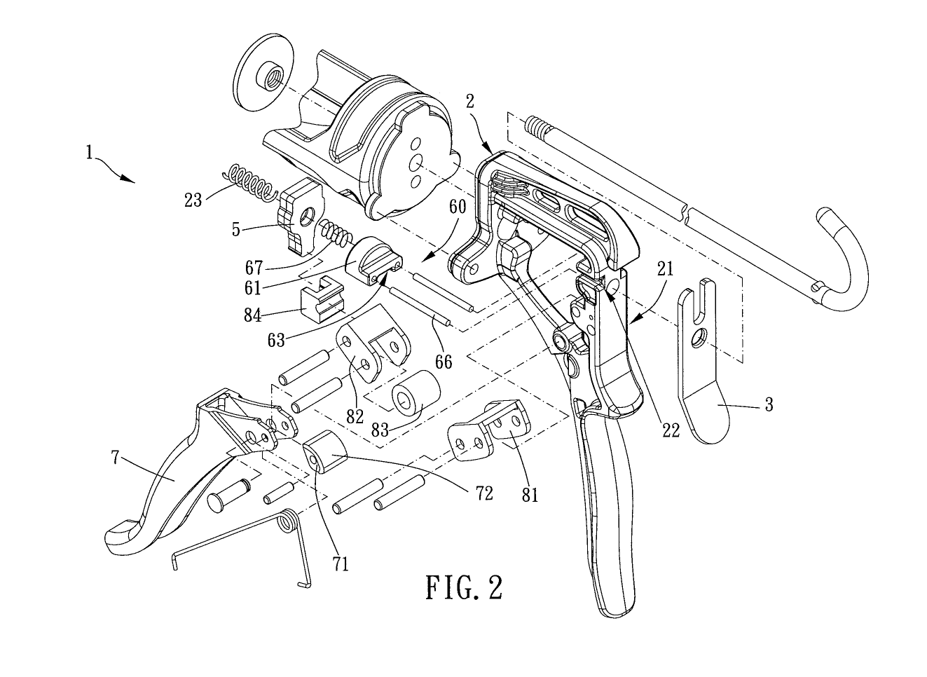

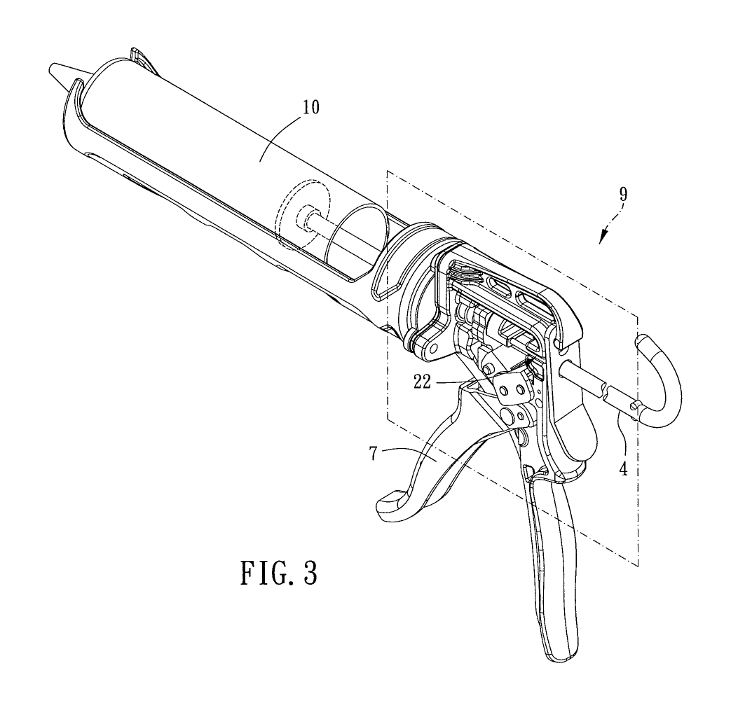

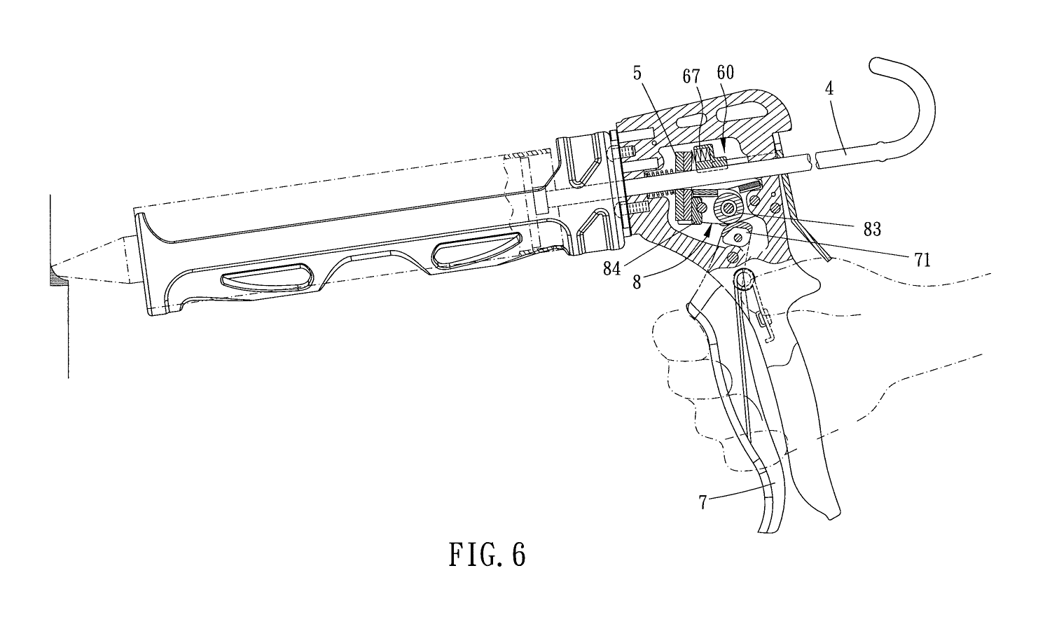

Please refer to FIGS. 1 to 6 for a preferred embodiment of the present invention. A caulking gun 1 includes a gun body 2, a limitation member 3, a pushing rod 4, a driving member 5 and an abutting mechanism 6.

The gun body 2 includes a lateral wall 21 and for a sealant cartridge 10 to be assembled thereto. The limitation member 3 is swingably assembled to the gun body 2, and when the limitation member 3 moves away from the side wall 21, the limitation member 3 restrict the pushing rod 4 to move away from the gun body 2. The pushing rod 4 is movably assembled to the gun body 2 and disposed through the limitation member 3 and the side wall 21, and the pushing rod 4 is optionally frictionally gripped by the limitation member 3 for pushing the sealant cartridge 10. The driving member 5 is movably disposed within the gun body 2, the driving member 5 and the limitation member 3 are located by two opposite sides of the side wall 21, the driving member 5 is capable of driving the pushing rod 4. The abutting mechanism 6 is movably disposed through the side wall 21 and radially disengageable directly from the pushing rod 4, two ends of the abutting mechanism 6 respectively abut against the driving member 5 and the limitation member 3, the abutting mechanism 6 includes an abutting portion 60 and an elastic member 67, the elastic member 67 is arranged between the abutting portion 60 and the driving member 5, and the elastic member 67 allows the abutting portion 60 to normally abut against and push the limitation member 3 to keep the limitation member 3 remote from the gun body 2. It is to be noted that the pushing rod 4 is not blocked by the abutting mechanism 6 on at least one radial direction and can move away from the pushing rod 4, and of course, when the abutting mechanism 6 and the pushing rod 4 are arranged in the caulking gun 1, both of the abutting mechanism 6 and the pushing rod 4 are positioned and unable to be separated radially.

In this embodiment, the abutting portion 60 includes a block body 61 and two pillar bodies 66 which project from the block body 61, the two pillar bodies 66 are movably disposed through the side wall 21, and the block body 61 and the two pillar bodies 66 respectively abut against the driving member 5 and the limitation member 3. The caulking body 1 further includes a pressing shank 7 which is pivoted to the gun body 2 and a linkage mechanism 8, the linkage mechanism 8 includes a first linkage 81 which is pivoted to the side wall 21 and a second linkage 82 which is pivoted to the first linkage 81, the second linkage 82 and the block body 61 are located by two sides of the pushing rod 4 and abut against the driving member 5, a place of the first linkage 81 and the second linkage 82 pivoted to each other further has a rotatable member 83, and the pressing shank 7 abuts against the rotatable member 83. The side wall 21 has two opening slots 22, and the two pillar bodies 66 are disposed through the two opening slots 22.

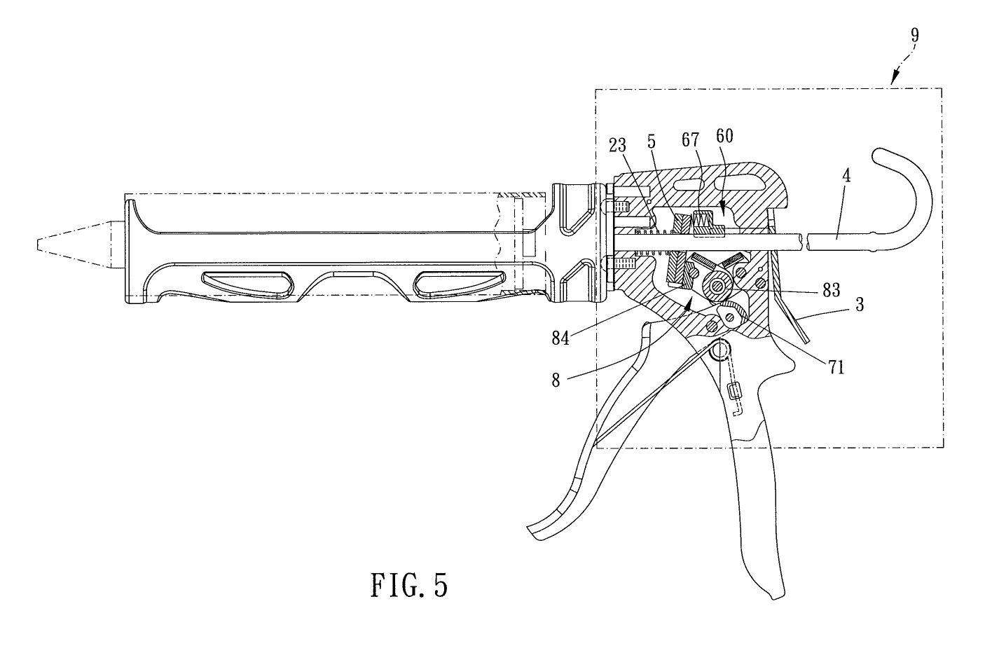

The limitation member 3 swings on a phantom plane 9 (a parallel paper plane in FIG. 5), the phantom plane 9 is parallel to a moving direction of the pushing rod 4 and also parallel to a radial direction of the rotatable member 83, and the two pillar bodies 66 are located by two sides of the phantom plane 9 and abut against the limitation member 3 simultaneously so that the limitation member 3 can moves stably. The block body 61 has a receiving groove 62 (as long as at least one of the driving member 5 and the block body 61 has the receiving groove), and the elastic member 67 is received in the receiving groove 62 so that the gun body 2 does not need to provide additional space for the elastic member 67 to be received therein. The block body 61 has a guiding groove 63, the guiding groove 63 is radially saddled above the pushing rod 64, and the guiding groove 63 can make the block body 61 positioned above the pushing rod and undetachable.

The pushing rod 4 is disposed through the driving member 5, a recovery elastic member 23 is further arranged between the driving member 5 and the gun body 2, and the recovery elastic member 23 enables the driving member 5 have a tendency to move toward the block body 61 normally; therefore, the driving member 5 is abutted and pushed by the recovery elastic member 23 and positioningly abutted by the linkage mechanism 8 to tilt normally, a part of the driving member 5 which is located above the pushing rod 4 tilts toward the side wall 21, and rest part of the driving member 5 which is located below the pushing rod 4 tilts toward the recovery elastic member 23 so that the driving member 5 normally abuts against the pushing rod 4 to ensure there is no non-actuating action in the caulking gun 1.

The first linkage 81 and the second linkage 82 form a V shape with an opening toward the pushing rod 4 so that the linkage mechanism 8 has a retractable space to abut against and push the driving member 5 or make the driving member 5 back to an initial position. The block body 61 and the two pillar bodies 66 are located by a same side of the pushing rod 4. The block body 61 includes a pushing head 64 which abuts against the driving member 5 and a connecting portion 65 which is thinner than the pushing head 64, and the two pillar bodies 66 are detachably inserted in the connecting portion 65 to strengthen a structural stability and for the convenience of replacing the block body 61 or the two pillar bodies 66.

The pressing shank 7 has a swinging member 71 which is pivotally arranged thereto, the swinging member 71 has a curved abutting face 72, the curved abutting face 72 abuts against the rotatable member 83, the curved abutting face 72 can decrease a friction between the pressing shank 7 and the linkage mechanism 8, the second linkage 82 is pinned with a pushing block 84, and the pushing block 84 abuts against the driving member 5 so as to decrease a friction between the driving member 5 and the linkage mechanism 8.

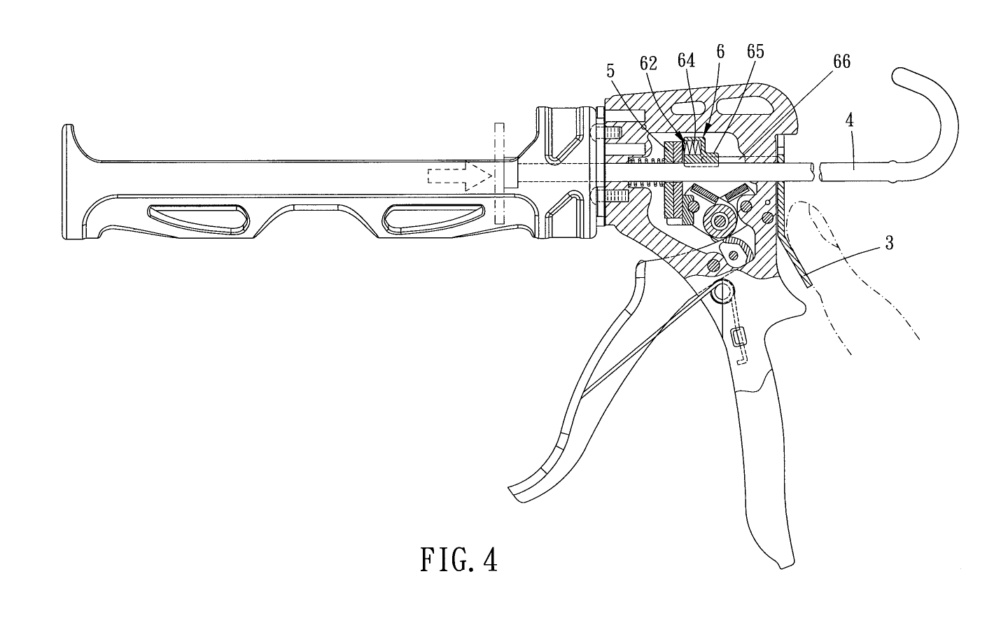

Please refer to FIGS. 4 to 6. When the limitation member 3 is pressed to actuate the abutting mechanism 6 to abut against and push the driving member 5, the driving member 5 is perpendicular to the pushing rod 4 and releases a restriction toward the pushing rod 4 to make the pushing rod 4 move away from the gun body 2. When the limitation member 3 is not pressed, the elastic member 67 drives the abutting portion 60 to abut against and push the limitation member 3 to make the limitation member 3 move away from the gun body 2, and after the gun body 2 is assembled to the sealant cartridge 10, the user can press the pressing shank 7 to make the linkage mechanism 8 to extend and push the driving member 5, and the driving member 5 drives the pushing rod 4 to push the sealant cartridge 10.

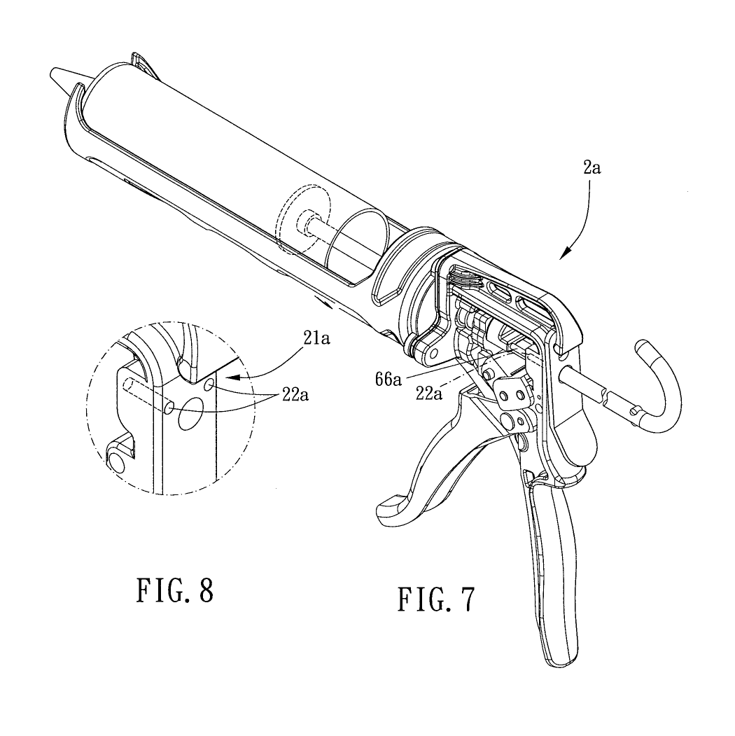

Please refer to FIGS. 7 and 8 for another embodiment. A side wall 21a of a gun body 2a may also has two through holes 22a, and two pillar bodies 66a are disposed through the two through holes 22a to stably guide and position the two pillar bodies 66a.

In other embodiments, the caulking gun may not have the pressing shank and/or the linkage mechanism and may instead drive the pushing rod electrically via a driving sheet; or the pressing shank directly abuts against the driving sheet, and the caulking gun may not have the linkage mechanism; according to different requirements, the two pillar bodies of the abutting mechanism may abut against the limitation member non-simultaneously, and the two pillar bodies may not be positioned by the two sides of the phantom plane; the driving member and the receiving groove of the caulking gun may both have a receiving groove, and two ends of the elastic member are respectively received in the two receiving grooves; the block body of the abutting mechanism may surround the pushing rod, and the block body and the two pillar bodies may not be positioned by the same side of the pushing rod; the elastic member of the abutting mechanism may be arranged between the block body and the side wall and make the block body move toward the limitation member normally; the driving member of the caulking gun may fixedly clamp the pushing rod in a non-circular mode, for example but not limited thereto, U-shaped; the driving member of the caulking gun may tilt normally toward other directions as long as the driving member abrades and actuates the pushing rod normally.

Give the above, the caulking gun does not have any non-actuating action, the guiding groove between the two pillar bodies and the block body can strengthen the balance and stability of the abutting structure, and the elastic member is received in the receiving groove of the block body to protect and streamline the structure and eliminate friction.

While we have shown and described various embodiments in accordance with the present invention, it should be clear to those skilled in the art that further embodiments may be made without departing from the scope of the present invention.

What is claimed is:

1. A caulking gun, including:
a gun body, including a side wall and for a sealant cartridge to be assembled thereto;
a limitation member, swingably assembled to the gun body;
a pushing rod, movably assembled to the gun body and disposed through the limitation member and the side wall, the pushing rod optionally frictionally gripped by the limitation member, being for pushing the sealant cartridge;
a driving member, movably disposed within the gun body, the driving member and the limitation member being located by two opposite sides of the side wall, the driving member capable of driving the pushing rod;
an abutting mechanism, movably disposed through the side wall and radially disengageable directly from the pushing rod, two ends of the abutting mechanism respectively abutting against the driving member and the limitation member, the abutting mechanism including an abutting portion and an elastic member, the elastic member being arranged between the abutting portion and the driving member.

2. The caulking gun of claim 1, wherein the abutting portion includes a block body and two pillar bodies which project from the block body, the two pillar bodies are movably disposed through the side wall, and the block body and the two pillar bodies respectively abut against the driving member and the limitation member.

3. The caulking gun of claim 2, wherein the side wall has two through holes, and the two pillar bodies are disposed through the two through holes.

4. The caulking gun of claim 2, wherein the limitation member swings on a phantom plane, and the two pillar bodies are located by two sides of the phantom plane.

5. The caulking gun of claim 2, wherein the side wall has two opening slots, and the two pillar bodies are disposed through the two opening slots.

6. The caulking gun of claim 2, wherein at least one of the driving member and the block body has a receiving groove, and the elastic member is received in the receiving groove.

7. The caulking gun of claim 2, wherein the two pillar bodies are detachably connected to the block body.

8. The caulking gun of claim 2, wherein the block body has a guiding groove, and the guiding groove is radially saddled above the pushing rod.

9. The caulking gun of claim 2, further including a pressing shank which is pivoted to the gun body and a linkage mechanism, the linkage mechanism including a first linkage which is pivoted to the side wall and a second linkage which is pivoted to the first linkage, the second linkage and the block body being located by two sides of the pushing rod and abutting against the driving member, a place of the first linkage and the second linkage pivoted to each other further having a rotatable member, the pressing shank abutting against the rotatable member.

10. The caulking gun of claim 9, wherein the side wall has two opening slots, and the two pillar bodies are disposed through the two opening slots; the limitation member swings on a phantom plane, and the two pillar bodies are located by two sides of the phantom plane and abut against the limitation member simultaneously; at least one of the driving member and the block body has a receiving groove, and the elastic member is received in the receiving groove; the two pillar bodies are detachably connected to the block body; the block body has a guiding groove, and the guiding groove is radially saddled above the pushing rod; the pushing rod is disposed through the driving member, a recovery elastic member is further arranged between the driving member and the gun body, and the recovery elastic member enables the driving member have a tendency to move toward the block body normally; the first linkage and the second linkage form a V shape with an opening toward the pushing rod; the block body and the two pillar bodies are located by a same side of the pushing rod; the block body includes a pushing head which abuts against the driving member and a connecting portion which is thinner than the pushing head, and the two pillar bodies are inserted in the connecting portion; the pressing shank has a swinging member which is pivotally arranged thereto, the swinging member has a curved abutting face, the curved abutting face abuts against the rotatable member, the second linkage is pinned with a pushing block, and the pushing block abuts against the driving member.
